(19) United States
(12) Patent Application Publication
(10) Pub. No.: US 2023/0347544 A1
(43) Pub. Date: Nov. 2, 2023

(54) WORKPIECE CUTTING DEVICE AND WORKPIECE CUTTING METHOD

(71) Applicant: IHI CORPORATION, Tokyo (JP)

(72) Inventors: Takuya SUNAKAWA, Tokyo (JP); Koichiro HAYASHI, Tokyo (JP); Kensuke HIRATA, Tokyo (JP); Wataru UEDA, Tokyo (JP)

(73) Assignee: IHI CORPORATION, Tokyo (JP)

(21) Appl. No.: 18/348,474

(22) Filed: Jul. 7, 2023

Related U.S. Application Data
(63) Continuation of application No. PCT/JP2022/008561, filed on Mar. 1, 2022.

(30) Foreign Application Priority Data
Mar. 2, 2021 (JP) 2021-032505

(51) Int. Cl. B26F 3/02; B26D 7/02; B26D 7/32

(52) U.S. Cl. CPC B26F 3/02; B26D 7/02; B26D 7/32

(57) ABSTRACT

Provided is a workpiece cutting device capable of reliably cutting a workpiece in a short period of time without damaging portions other than seams and without leading to an increase in size of the device in a case where the device is used to cut a workpiece formed into a sheet shape by partially coupling a plurality of small pieces to each other, for example. A workpiece cutting device that cuts a sheet-shaped or thin plate-shaped workpiece into a first-side workpiece and a second-side workpiece includes a securing mechanism that secures the first-side workpiece, a gripping and turning mechanism that grips the second-side workpiece and turns the second-side workpiece about a seam with the first-side workpiece as an axis, and a separating piece insertion mechanism that separates the first-side workpiece and the second-side workpiece at a vulnerable portion formed at the seam through a turning operation of the second-side workpiece performed by the gripping and turning mechanism.

### TECHNICAL FIELD

The present disclosure relates to a workpiece cutting device and a workpiece cutting method used to cut a sheet-shaped or thin plate-shaped workpiece.

### BACKGROUND ART

In the related art, devices as described in Patent Documents 1 to 3, for example, are known as devices for cutting sheet-shaped or thin plate-shaped workpieces as described above.

The device described in Patent Document 1 is a cutting device for a sheet-shaped molded article that includes a blade portion formed into a receiving shape to allow a sheet-shaped molded article to be placed thereon and a movable blade moving up and down with respect to the blade portion with the receiving shape and is adapted to cut the sheet-shaped molded article through cooperation of the blade portion and the movable blade.

The device described in Patent Document 2 is a cutting device for a sheet that cuts a sheet along a perforated line, includes a rotation shaft and a cutting shaft turning about the rotation shaft, and is adapted to cut the sheet via the perforated line by applying a tensile force caused by friction to the sheet in a state where the cutting shaft is in contact with a position of the perforated line on the sheet.

The device described in Patent Document 3 is a pressurization cutting device that cuts a flat plate-shaped workpiece along a marking-off line, includes support means for supporting the workpiece and pressurizing means including a pressurizing surface disposed to face the support means such that the pressurizing means can come into contact with and be separated from the support means, and is adapted to cut the workpiece along the marking-off line by pressurizing the workpiece supported by the support means in such a way to fold and cut the workpiece by the pressurizing surface of the pressurizing means.

Here, a process of manufacturing light-weight and high-strength carbon fiber reinforced plastics (CFRP) or glass fiber reinforced plastics (GFRP) that have widely been used as constituent materials of vehicles, aircrafts, and the like in recent years includes a step of stacking and pressing a plurality of small pieces (small pieces of CFRP or GFRP) formed into a strip shape.

At this time, a method of arranging the plurality of small pieces in parallel with each other, partially coupling adjacent small pieces to each other to obtain a sheet-shaped workpiece, and then supplying the workpiece has been employed in order to facilitate handling until the press step, and an operator's operation of tearing off the small pieces one by one from the workpiece supplied in the sheet shape and stacking them in a mold is performed in the press step.

It is a matter of course that automation of the operation of separating the small pieces from the workpiece supplied in the sheet shape has been demanded, and employing of each of the cutting devices described in Patent Documents 1 to 3 described above, for example, has been considered in order to achieve the automation of the cutting of the partially coupled small pieces.

### RELATED ART DOCUMENT

### Patent Document

Patent Document 1: Japanese Patent Laid-Open No. 2008-006547

Patent Document 2: Japanese Patent Laid-Open No. 2012-076381

Patent Document 3: Japanese Patent Laid-Open No. 2004-209675

### SUMMARY OF THE DISCLOSURE

### Problems to be Solved by the Disclosure

In a case where the cutting device that cuts a sheet-shaped molded article through cooperation of the blade portion and the movable blade described in Patent Document 1 is employed as a device that automatically performs cutting at seams of partially coupled small pieces (small pieces of CFRP or GFRP), there is a concern that if a positioning error occurs in the small pieces due to dimensional variations or the like, the blade portion and the movable blade deviate from the position of the seams, and portions other than the seams are damaged.

Also, in a case where the device that applies a tensile force to a sheet and cuts the sheet as described in Patent Document 2 is employed to perform the aforementioned cutting at the seams of the small pieces, since tensile strength of fiber in CFRP or GFRP is high, not only the tensile force to be applied to the small pieces but also a force for gripping the small pieces are to be increased by considerable amounts, which may lead to an increase in size of the device.

Furthermore, in a case where the pressurization cutting device that folds and cuts a workpiece along a marking-off line as described in Patent Document 3 is employed to automatically perform cutting at the seams of the partially coupled small pieces, a sufficiently large folding angle is to be set. Additionally, the folding is to be repeated a plurality of times to achieve cutting even if a large folding angle is set, and the number of times the folding is to be repeated significantly differs depending on variations in physical properties caused in the process of manufacturing the small pieces. Therefore, the folding is to be repeated a number of times until each of the strip-shaped small pieces can be reliably cut, it takes long time to perform the cutting operation, and solving these problems is a task to achieve automation.

The present disclosure was made in order to solve the problems in the related art as described above, and an object thereof is to provide a workpiece cutting device capable of reliably cutting a workpiece in a short period of time without damaging portions other than seams and without leading to an increase in size of the device in a case where the device is used to cut a workpiece formed into a sheet shape by partially coupling a plurality of small pieces (small pieces of CFRP or GFRP) to each other along seams of the small pieces, for example.

### Means for Solving the Problems

An aspect of the present disclosure is directed to a workpiece cutting device that cuts a sheet-shaped or thin plate-shaped workpiece into a first-side workpiece and a second-side workpiece including a securing mechanism that secures the first-side workpiece, a gripping mechanism that grips the second-side workpiece, a turning mechanism that turns the second-side workpiece gripped by the gripping mechanism around a boundary with the first-side workpiece as an axis, and separating mechanism that separates the first-side workpiece and the second-side workpiece at a vulnerable portion formed at the boundary through a turning operation of the second-side workpiece performed by the turning mechanism.

### Effects of the Disclosure

The workpiece cutting device according to the present disclosure has a significantly excellent effect that it is possible to reliably cut small pieces in a short period of time without damaging portions other than seams and without leading to an increase in size of the device in a case where the device is used to cut the small pieces of a workpiece formed into a sheet shape by partially coupling the plurality of small pieces (small pieces of CFRP or GFRP) to each other, for example.

### BRIEF DESCRIPTION OF THE DRAWINGS

FIG. 1 is an explanatory diagram of a sheet-shaped workpiece that is obtained by partially coupling a plurality of strip-shaped small pieces to each other and illustrates an example of a sheet-shaped workpiece to be cut by a workpiece cutting device according to the present disclosure.

FIG. 2 is a sectional explanatory diagram of a workpiece cutting device according to an embodiment of the present disclosure seen from a side surface direction.

FIG. 3 is a sectional explanatory diagram based on an A-A line in FIG. 2 of the workpiece cutting device in FIG. 2.

FIG. 4 is a front explanatory diagram of the workpiece cutting device in FIG. 2.

FIG. 5 is a partially enlarged explanatory diagram of the inside of a circle in FIG. 2.

FIG. 6 is a planar explanatory diagram illustrating a transferring mechanism of the workpiece cutting device in FIG. 2.

FIG. 7A is an operation explanatory diagram illustrating a situation in which cutting of a sheet-shaped workpiece and extraction of a cut small piece are being performed by using the workpiece cutting device in FIG. 6.

FIG. 7B is an operation explanatory diagram illustrating the situation in which cutting of the sheet-shaped workpiece and extraction of the cut small piece are being performed by using the workpiece cutting device in FIG. 6.

FIG. 7C is an operation explanatory diagram illustrating the situation in which cutting of the sheet-shaped workpiece and extraction of the cut small piece are being performed by using the workpiece cutting device in FIG. 6.

FIG. 7D is an operation explanatory diagram illustrating the situation in which cutting of the sheet-shaped workpiece and extraction of the cut small piece are being performed by using the workpiece cutting device in FIG. 6.

FIG. 7E is an operation explanatory diagram illustrating the situation in which cutting of the sheet-shaped workpiece and extraction of the cut small piece are being performed by using the workpiece cutting device in FIG. 6.

FIG. 7F is an operation explanatory diagram illustrating the situation in which cutting of the sheet-shaped workpiece and extraction of the cut small piece are being performed by using the workpiece cutting device in FIG. 6.

FIG. 7G is an operation explanatory diagram illustrating the situation in which cutting of the sheet-shaped workpiece and extraction of the cut small piece are being performed by using the workpiece cutting device in FIG. 6.

FIG. 8 is an enlarged explanatory diagram that corresponds to the inside of the circle in FIG. 2 and illustrates a behavior at the time when cutting of a sheet-shaped workpiece is performed by using the workpiece cutting device in FIG. 6.

FIG. 9 is a front explanatory diagram of a workpiece cutting device according to another embodiment of the present disclosure.

### MODE FOR CARRYING OUT THE DISCLOSURE

Hereinafter, embodiments of the present disclosure will be described on the basis of the drawings.

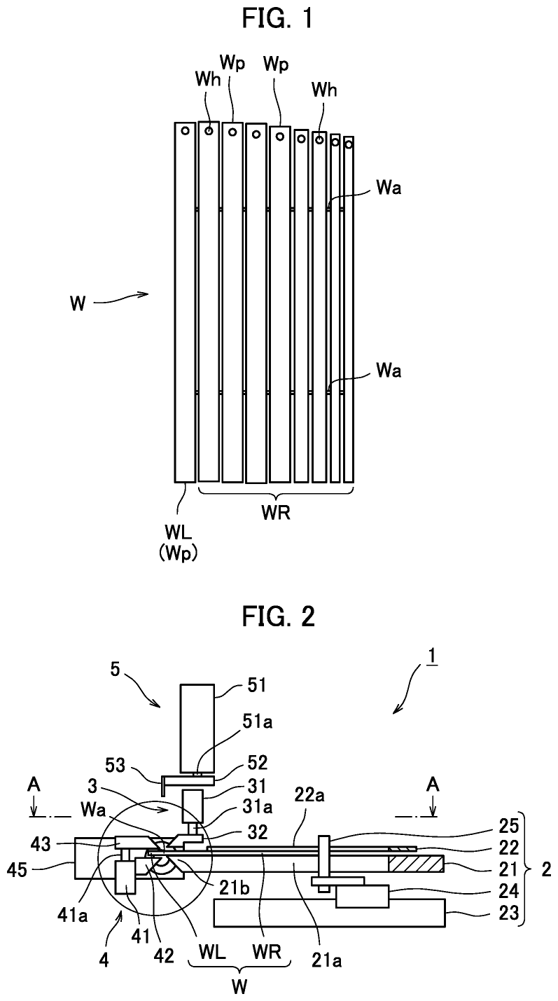

In this embodiment, a case where a workpiece cutting device according to the present disclosure is used to automatically cut a sheet-shaped workpiece W illustrated in FIG. 1, that is, a workpiece W formed into a sheet shape by partially coupling a plurality of small pieces (small pieces of CFRP or GFRP) Wp to each other along seams Wa is illustrated.

As illustrated in FIG. 2, a workpiece cutting device 1 according to an embodiment of the present disclosure is a device that cuts the sheet-shaped workpiece W described above into a first-side workpiece WR and a second-side workpiece WL, and in this case, the “first-side workpiece WR” indicates an entire right-side part in which a plurality of small pieces Wp are continued except for the small piece Wp located at a left end of the sheet-shaped workpiece W in FIG. 1, and the “second-side workpiece WL” indicates only the small piece Wp at the left end in FIG. 1. In other words, the second small piece Wp from the left end in FIG. 1 serves as the second-side workpiece after the small piece Wp at the left end in FIG. 1 serving as the second-side workpiece is cut as will be described later.

The workpiece cutting device 1 according to the present embodiment includes a feeding mechanism 2, a securing mechanism 3, a gripping and turning mechanism 4, a separating piece insertion mechanism (separating mechanism) 5, and a transferring mechanism 8.

The feeding mechanism 2 includes a guide plate 21 on which the sheet-shaped workpiece W is placed, a pressing plate 22 for preventing buckling of the workpiece that is disposed on the guide plate 21 in an overlapping manner at substantially the same gap as the thickness of the workpiece W, a rail 23 disposed from a workpiece transport-in end portion side (the right end portion side in FIG. 2) to a workpiece cutting end portion side (the left end portion side in FIG. 2) of the guide plate 21, a slider 24 that reciprocates on the rail 23 in response to an output from a drive source, which is not illustrated, and a pin 25 disposed on the slider 24.

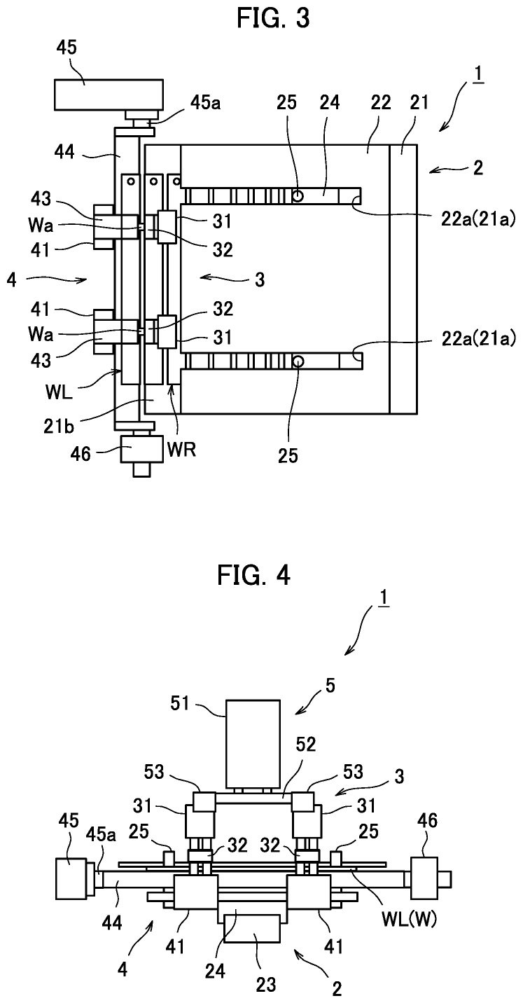

The guide plate 21 and the pressing plate 22 includes grooves 21a and 22a formed therein along the rail 23 such that the pin 25 penetrates through the grooves 21a and 22a as illustrated in FIG. 3, and the pin 25 is adapted to move inside the grooves 21a and 22a with movement of the slider 24 on the rail 23. The pin 25 moves at a predetermined stroke to press the workpiece W on the workpiece cutting end portion side by a predetermined amount during a workpiece feeding operation.

Note that in the feeding mechanism 2, a suctioning hole may be disposed in the guide plate 21 instead of the pressing plate 22, for example, and the workpiece W may be pressed through vacuum adsorption. Also, a belt conveyor or the like may be employed instead of the feeding mechanism 2.

The securing mechanism 3 includes an air cylinder 31 disposed along a vertical direction above the workpiece cutting end portion of the guide plate 21, an upper pressurizing portion 32 that is provided at a distal end of a cylinder rod 31a of the air cylinder 31 and moves up and down, and a workpiece cutting end portion 21b of the guide plate 21 configuring a clamp along with the upper pressurizing portion 32. In this embodiment, two sets of air cylinders 31 and upper pressurizing portions 32 are disposed in a width direction of the workpiece W (the up-down direction in FIG. 3, the left-right direction in FIG. 4), and the securing mechanism 3 achieves securing by pinching the first-side workpiece WR of the workpiece W transferred to a predetermined position by the feeding mechanism 2 with the two sets of upper pressurizing portions 32 and the workpiece cutting end portions 21 of the guide plates 21 as illustrated in FIG. 4 as well.

The gripping and turning mechanism 4 includes an air cylinder 41 disposed along a vertical direction on the side further downstream of the workpiece feeding (the left side in FIGS. 2 and 3) than the workpiece cutting end portion 21b of the guide plate 21, a receiving portion 42 secured to the air cylinder 41, and an upper pressurizing portion 43 provided at a distal end of a cylinder rod 41a of the air cylinder 41 and configuring a clamp along with the receiving portion 42. Two sets of receiving portions 42 (air cylinders 41) and upper pressurizing portions 43 configuring a clamp are disposed to face the two sets of air cylinders 31 and upper pressurizing portions 32 of the securing mechanism 3, and these two sets of receiving portions 42 and upper pressurizing portions 43 are adapted to achieve securing by pinching the second-side workpiece WL (the small piece Wp projecting from the workpiece cutting end portion 21b of the guide plate 21) of the workpiece W transferred to a predetermined position by the feeding mechanism 22 in this embodiment as well.

Additionally, the gripping and turning mechanism 4 includes a shaft 44 disposed in the width direction of the workpiece W along the workpiece cutting end portion 21b of the guide plate 21 and a rotary air cylinder 45 disposed at an upper end portion in FIG. 3 (left end portion in FIG. 4) in the width direction of the workpiece W, and the shaft 44 is coupled to a rotation shaft 45a of the rotary air cylinder 45 in an offset state. Also, the two sets of receiving portions 42 and upper pressurizing portions 3 pinching and securing the second-side workpiece WL (small piece Wp) of the workpiece W are secured to the shaft 44. In other words, the two sets of receiving portions 42 and upper pressurizing portions 43 integrated with the shaft 44 can be turned about the rotation shaft 45a in response to an output from the rotary air cylinder 45 between the rotation shaft 45a of the rotary air cylinder 45 and a bearing 46 disposed on an extension line of the rotation shaft 45a in the gripping and turning mechanism 4. In other words, it is possible to fold (rotate) upward or downward the second-side workpiece WL pinched between and secured by the two sets of receiving portions 42 and upper pressurizing portions 43 in the gripping and turning mechanism 4 at a seam (boundary) Wa between the first-side workpiece WR and the second-side workpiece WL located between the securing mechanism 3 and the gripping and turning mechanism 4.

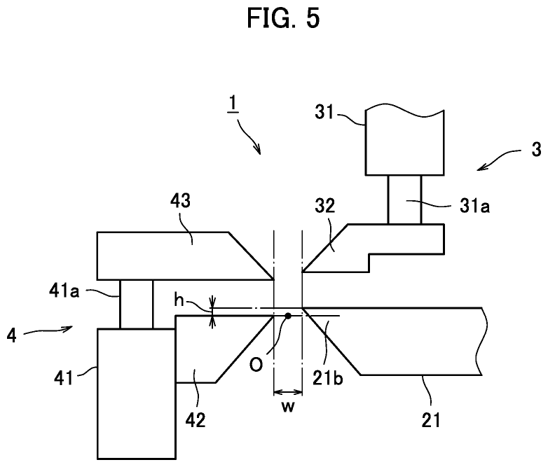

At this time, a turning center O of the two sets of receiving portions 42 and upper pressurizing portions 43 integrated with the shaft 44 that also serving as a rotation center of the second-side workpiece WL is preferably located at substantially the center of a clearance with a width w between the securing mechanism 3 and the gripping and turning mechanism 4 as illustrated in FIG. 5. In addition, in order to prevent an end portion of the workpiece W from being hooked at the clearance when the feeding mechanism 2 transfers the workpiece W on the guide plate 21 to the predetermined position, it is preferable that a slight step difference h be formed between the workpiece cutting end portion 21b on the side of the securing mechanism 3 and the receiving portion 42 on the side of the gripping and turning mechanism 4 such that the receiving portion 42 is located to be lower than the workpiece cutting end portion 21b.

The separating piece insertion mechanism 5 includes an air cylinder 51 disposed along the vertical direction above the workpiece cutting end portion of the guide plate 21, a holder 52 provided at a distal end of a cylinder rod 51a of the air cylinder 51, and a separating piece 53 having a thin plate shape with a sharp distal end, supported by the holder 52, and moving up and down along with the holder 52. The separating piece insertion mechanism 5 is adapted to separate the second-side workpiece WL (small piece Wp) from the first-side workpiece WR by inserting, through a rod pushing-out operation of the air cylinder 51, the separating piece 53 into a vulnerable portion formed at the seam Wa through the folding operation (turning operation) of the second-side workpiece WL performed by the gripping and turning mechanism 4. Note that although not illustrated, the air cylinder 51 is provided with an automatic switch such that it is possible to detect whether or not the separating piece 53 has passed through the seam Wa of the workpiece W.

Note that the separating piece 53 is not limited to one with a sharp distal end in the separating piece insertion mechanism 5. Also, a guide or a spring that guides the separating piece 53 to the seam Wa of the workpiece W may be provided between the holder 52 and the separating piece 53.

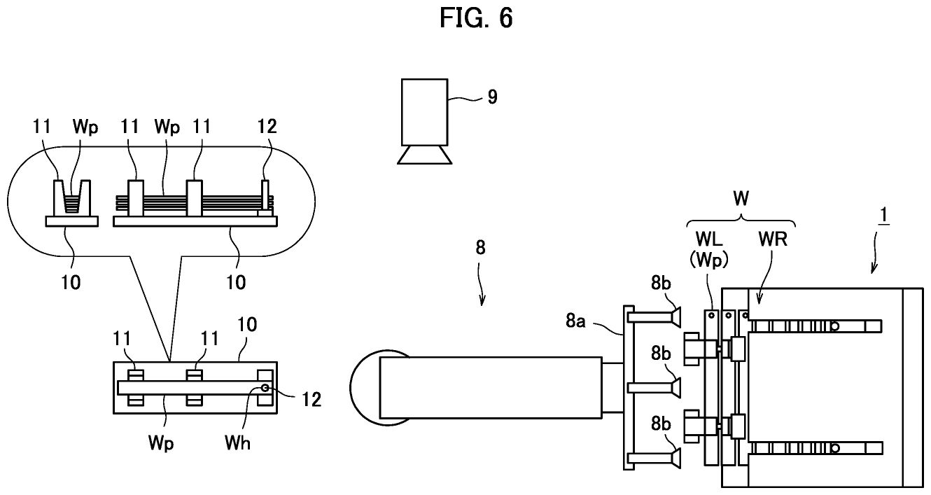

The transferring mechanism 8 is a robot arm disposed in the vicinity of the gripping and turning mechanism 4 as illustrated in FIG. 6, and the robot arm includes a hand 8a including a plurality of vacuum adsorption portions 8b at a distal end. At this time, an image sensor 9 for recognizing a position of a hole Wh provided at the small piece Wp of the workpiece W and a workpiece stacking jig 10 configured by a guide block 11 and a positioning pin 12 for stacking the small piece Wp of the workpiece W are disposed in the surroundings of the robot arm. The transferring mechanism 8 is adapted to suction the strip-shaped small piece Wp separated from the first-side workpiece WR by the separating piece insertion mechanism 5 to the vacuum adsorption portions 8b of the hand 8a, take the small piece Wp from the gripping and turning mechanism 4, transferring the small piece Wp to the workpiece stacking jig 10, and stacking the small piece Wp.

Next, how to cut the sheet-shaped workpiece W and take the cut second-side workpiece WL (small piece Wp) by using the workpiece cutting device 1 according to the embodiment will be described.

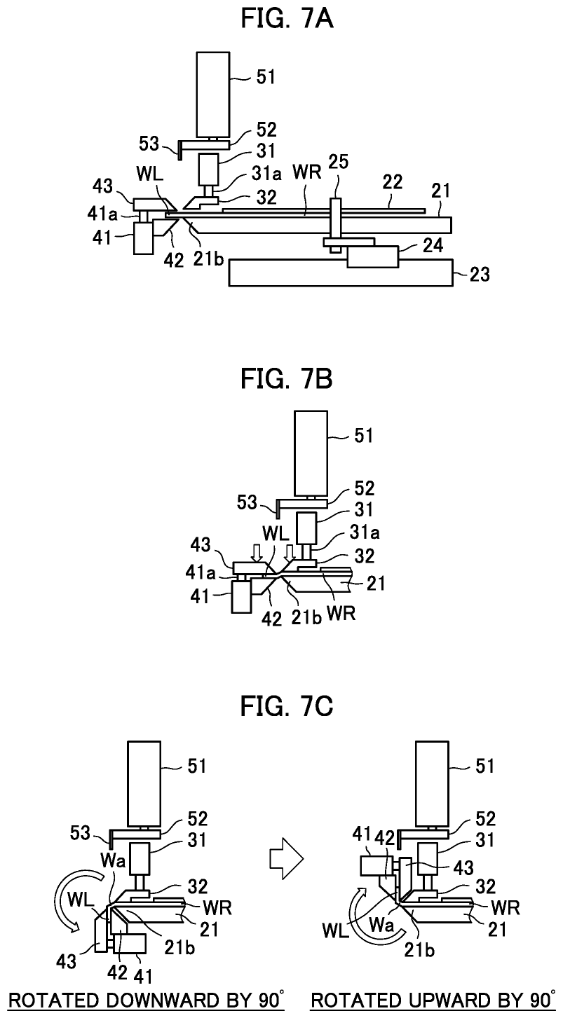

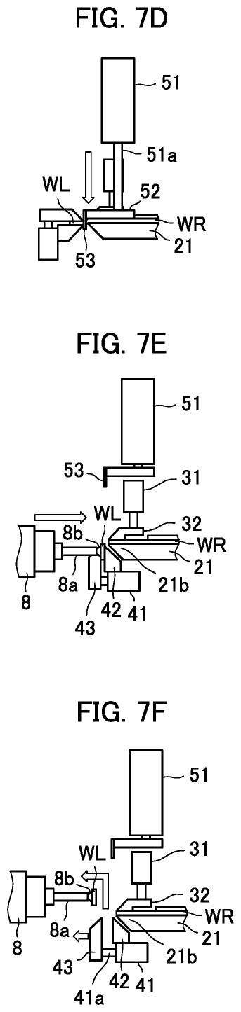

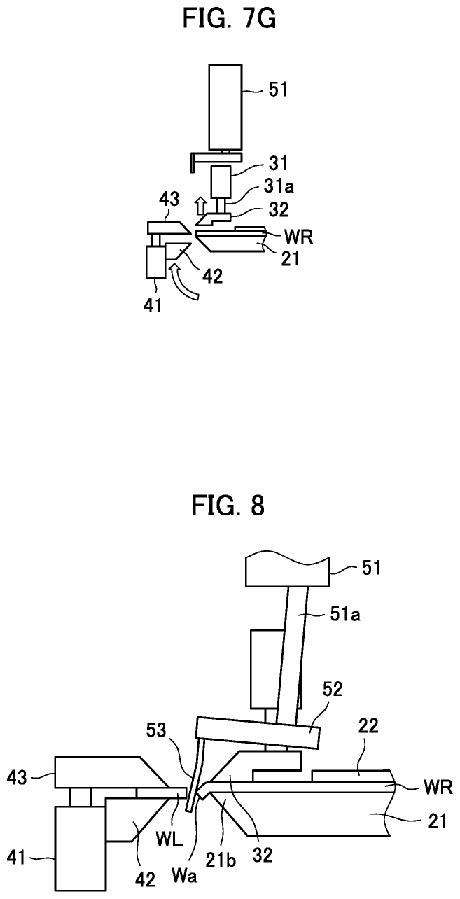

First, the pin 25 moves by a predetermined stroke in response to an output from a drive source, which is not illustrated, of the feeding mechanism 2, the workpiece W set between the guide plate 21 and the pressing plate 22 for preventing buckling of the workpiece is pressurized on the side of the workpiece cutting end portion of the guide plate 21 by a predetermined amount, and the first-side workpiece WR and the second-side workpiece WL are caused to be located at the locations of the securing mechanism 3 and the gripping and turning mechanism 4, as illustrated in FIG. 7(a).

In this state, the air cylinder 31 of the securing mechanism 3 operates to clamp and secure the first-side workpiece WR, and the air cylinder 41 of the gripping and turning mechanism 4 then operates to clamp and secure the second-side workpiece WL as illustrated in FIG. 7(b) (securing step and gripping step). At this time, the first-side workpiece WR is secured first because there is a concern of pulling the entire workpiece W and causing positional deviation if the second-side workpiece WL side is clamped first.

Once the securing mechanism 3 and the gripping and turning mechanism 4 secure the workpiece W, the rotary air cylinder 45 of the gripping and turning mechanism 4 operates to successively turn the receiving portions 42 and the upper pressurizing portions 43 in forward and backward directions as illustrated in FIG. 7(c), in other words, folds the second-side workpiece WL pinched between and secured by the receiving portions 42 and the upper pressurizing portions 43 upward and downward by 90°, respectively, a plurality of times at the seam (boundary) Wa between the first-side workpiece WR and the second-side workpiece WL located between the securing mechanism 3 and the gripping and turning mechanism 4.

Then, the receiving portions 42 and the upper pressurizing portions 43 of the gripping and turning mechanism 4 are turned to original positions before the operation, and the air cylinder 51 of the separating piece insertion mechanism 5 operates on the vulnerable portion formed at the seam Wa through the folding performed by the gripping and turning mechanism 4 to pierce the separated piece 53 (separating step) as illustrated in FIG. 7(d). At this time, whether the separating piece 53 has passed through the seam Wa of the workpiece W is detected by an automatic switch of an air cylinder, which is not illustrated, the cutting is determined to have been completed in a case where passing has been detected, or the cutting is determined not to have been completed in a case where passing has not been detected, and the folding of the second-side workpiece WL is performed again by the gripping and turning mechanism 4.

In a case where cutting is determined to have been completed, the second-side workpiece WL pinched between and secured by the receiving portions 42 and the upper pressurizing portions 43 of the gripping and turning mechanism 4 is folded downward by 90°, and the robot arm that is the transferring mechanism 8 then operates to cause the vacuum adsorption portions 8b of the hand 8a to adsorb the second-side workpiece WL (strip-shaped small piece Wp) separated from the first-side workpiece WR as illustrated in FIG. 7(e).

After the adsorption of the second-side workpiece WL achieved by the vacuum adsorption portions 8b of the hand 8a is completed, the pinching and the securing of the second-side workpiece WL achieved by the receiving portions 42 and the upper pressurizing portions 43 of the gripping and turning mechanism 4 are released, and the robot arm that is the transferring mechanism 8 takes the second-side workpiece WL out between the receiving portions 42 and the upper pressurizing portions 43 of the gripping and turning mechanism 4 as illustrated in FIG. 7(f).

Thereafter, the receiving portions 42 and the upper pressurizing portions 43 of the gripping and turning mechanism 4 are returned to the original positions before the operation, and the feeding mechanism 2 restarts the operation to cut the next second-side workpiece WL (the second small piece Wp from the left end in FIG. 1) and pushes the workpiece W on the side of the workpiece cutting end portion by the predetermined amount as illustrated in FIG. 7(g).

At this time, the robot arm that is the transferring mechanism 8 transports the second-side workpiece WL (strip-shaped small piece Wp) adsorbed by the vacuum adsorption portions 8b of the hand 8a to the vicinity of the image sensor 9, and the position of the hole Wh pierced in the small piece Wp is detected by the image sensor 9. Then, the teaching point of the robot arm is corrected on the basis of the detection result, and the adsorption achieved by the vacuum adsorption portions 8b is released by causing the positioning pin 12 to pass through the hole Wh inside the guide block 11 of the workpiece stacking jig 10.

As described above, the workpiece cutting device 1 according to the embodiment is adapted such that the gripping and turning mechanism 4 is caused to perform the folding operation on the second-side workpiece WL of the workpiece W at the seam (boundary) Wa between the first-side workpiece WR and the second-side workpiece WL and the separating piece 53 of the separating piece insertion mechanism 5 is then pierced to the vulnerable portion formed at the seam Wa through the folding operation.

In other words, even if a small left portion (uncut fiber) remains at the vulnerable portion after the folding operation of the second-side workpiece WL of the workpiece W, the part corresponding to the left portion is removed by the insertion of the separating piece 53, and it is thus possible to reliably cut the second-side workpiece WL of the workpiece W by inserting the separating piece 53 of the separating piece insertion mechanism 5 into the vulnerable portion after the folding operation regardless of whether there is such a left portion.

Therefore, the workpiece cutting device 1 according to the embodiment can minimize the number of times the folding operation of the second-side workpiece WL of the workpiece W is to be performed and shorten the time to perform the cutting.

Also, since the workpiece cutting device 1 according to the present embodiment employs the air cylinder 51 as an operation source of the separating piece insertion mechanism 5, the separating piece 53 is inserted between the upper pressurizing portions 32 of the securing mechanism 3 and the upper pressurizing portions 43 of the gripping and turning mechanism 4 by following the seam Wa due to backlash that the air cylinder 51 of the separating piece insertion mechanism 5 has and deflection of the separating piece 53 itself that is a thin plate as illustrated in FIG. 6 even if the seam Wa of the workpiece W slightly deviates from the predetermined position, and damaging of portions other than the seam Wa of the workpiece W is thus minimized.

Additionally, since the workpiece cutting device 1 according to the embodiment is adapted such that the gripping and turning mechanism 4 is caused to perform the folding operation on the second-side workpiece WL of the workpiece W and the separating piece 53 of the separating piece insertion mechanism 5 is inserted into the vulnerable portion formed at the seam Wa through the folding operation, there is no need to pull the workpiece W with a stronger force or to grip the workpiece W with a larger force as compared with the cutting devices in the related art. Therefore, it is possible to use small-sized air cylinders as operation sources for gripping and cutting and thereby to realize a decrease in entire size of the device as well.

Furthermore, since the workpiece cutting device 1 according to the embodiment is formed to include the feeding mechanism 2 that moves the first-side workpiece WR in a state where securing by the securing mechanism 3 has been released toward the gripping and turning mechanism 4 by the predetermined amount, it is possible to continuously and smoothly cut the plurality of small pieces Wp in the cutting of the workpiece W formed into a sheet shape by partially coupling the plurality of small pieces (small pieces of CFRP or GFRP) Wp to each other at the seam Wa.

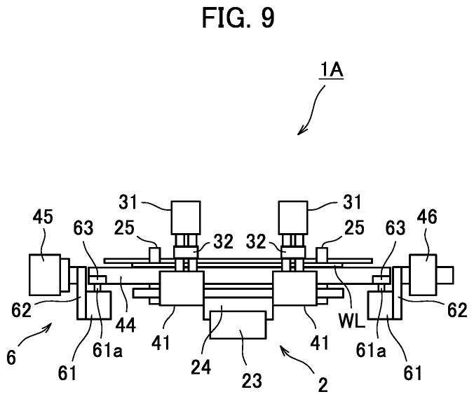

FIG. 9 illustrates a workpiece cutting device according to another embodiment of the present disclosure, and even in the embodiment, a case where the workpiece cutting device according to the present disclosure is used to automatically cut a sheet-shaped workpiece W illustrated in FIG. 1, that is, a workpiece W formed into a sheet shape by partially coupling a plurality of small pieces (small pieces of CFRP or GFRP) Wp to each other at seams Wa will be described.

As illustrated in FIG. 9, a workpiece cutting device 1A is different from the workpiece cutting device 1 according to the previous embodiment in that the workpiece cutting device 1A employs, as a separating mechanism, a drive mechanism 6 that moves the second-side workpiece WL upward in the drawing (in the direction separating from the first-side workpiece) to separate the second-side workpiece WL from the first-side workpiece at a vulnerable portion instead of the separating piece insertion mechanism 5 including the separating piece 53, and the other configurations are the same as those of the workpiece cutting device 1 according to the previous embodiment.

The drive mechanism 6 serving as a separating mechanism of the workpiece cutting device 1A according to the embodiment includes lifting and lowering cylinders 61 and 61 secured to the gripping and turning mechanism 4 of the workpiece cutting device 1 according to the previous embodiment on the side of the rotary air cylinder 45 and the side of the bearing 46, respectively, via a holder 62 and adaptors 63 and 63 disposed at distal ends of rods 61a and 61a of the lifting and lowering cylinders 61 and 61.

In this embodiment, a shaft 44 is bridged between the adaptors 63 and 63 of the drive mechanism 6, and it is possible to achieve cutting by causing the entire clamp part of the gripping and turning mechanism 4 to move upward through operations of the lifting and lowering cylinders 61 and 61 after the folding operation of the second-side workpiece WL performed by the gripping and turning mechanism 4 and tearing off the second-side workpiece WL at the seam Wa.

In this case, there is a concern that positional deviation may occur in the second-side workpiece WL or a first-side workpiece WR if the gripping force of the clamp portion of the gripping and turning mechanism 4 is small, and attention is thus to be paid to set the gripping force.

In this embodiment, a structure for determining cutting of the second-side workpiece WL through an operation stroke of the lifting and lowering cylinder 61 may be added.

The configuration of the workpiece cutting device according to the present disclosure is not limited to the aforementioned embodiments and can be modified in various manners without departing from the scope of the present disclosure.

Also, although the case where the workpiece cutting device according to the present disclosure is employed to cut a sheet-shaped workpiece has been described in the aforementioned embodiments, it is also possible to employ the workpiece cutting device according to the present disclosure to cut a thin plate-shaped workpiece.

### Aspects of Present Disclosure

A first aspect of the present disclosure is a workpiece cutting device that cuts a sheet-shaped or thin plate-shaped workpiece into a first-side workpiece and a second-side workpiece, the device is formed to include: a securing mechanism that secures the first-side workpiece; a gripping mechanism that grips the second-side workpiece; a turning mechanism that turns the second-side workpiece gripped by the gripping mechanism about a boundary with the first-side workpiece as an axis; and a separating mechanism that separates the first-side workpiece and the second-side workpiece at a vulnerable portion formed at the boundary through a turning operation of the second-side workpiece performed by the turning mechanism.

Also, a second aspect of the present disclosure is formed to include a feeding mechanism that moves the first-side workpiece in a state where securing by the securing mechanism has been released toward the turning mechanism by a predetermined amount.

Furthermore, a third aspect of the present disclosure is configured such that the separating mechanism is a separating piece insertion mechanism that inserts a thin plate-shaped separating piece into the vulnerable portion to separate the first-side workpiece and the second-side workpiece.

Moreover, a fourth aspect of the present disclosure is configured such that the separating mechanism is a drive mechanism that moves the second-side workpiece in a direction separating from the first-side workpiece to separate the second-side workpiece from the first-side workpiece at the vulnerable portion.

Furthermore, a fifth aspect of the present disclosure is formed to include a transferring mechanism that transfers the second-side workpiece to a stacking jig for stacking the second-side workpiece separated from the workpiece and stacks the second-side workpiece.

A sixth aspect of the present disclosure is formed to include, when a sheet-shaped or thin plate-shaped workpiece is cut into a first-side workpiece and a second-side workpiece by the workpiece cutting device according to any one of the above first to fourth aspects: a securing step of securing the first-side workpiece by the securing mechanism; a gripping step of gripping the second-side workpiece by the gripping mechanism; a folding step of turning the second-side workpiece gripped by the gripping mechanism about a boundary with the first-side workpiece as an axis by the turning mechanism; and a separating step of separating the first-side workpiece and the second-side workpiece by the separating mechanism at a vulnerable portion formed at the boundary in the folding step.

### Explanation of Reference Signs

1, 21A Workpiece cutting device
2 Feeding mechanism
3 Securing mechanism
4 Gripping and turning mechanism
5 Separating piece insertion mechanism (separating mechanism)
6 Drive mechanism (separating mechanism)
8 Transferring mechanism
53 Separating piece
W Workpiece
Wa Seam (boundary)
WL Second-side workpiece
WR First-side workpiece

1. A workpiece cutting device that cuts a sheet-shaped or thin plate-shaped workpiece into a first-side workpiece and a second-side workpiece, the device comprising:
a securing mechanism that secures the first-side workpiece;
a gripping mechanism that grips the second-side workpiece;
a turning mechanism that turns the second-side workpiece gripped by the gripping mechanism about a boundary with the first-side workpiece as an axis; and
a separating mechanism that separates the first-side workpiece and the second-side workpiece at a vulnerable portion formed at the boundary through a turning operation of the second-side workpiece performed by the turning mechanism.

2. The workpiece cutting device according to claim 1, comprising:
a feeding mechanism that moves the first-side workpiece in a state where securing by the securing mechanism has been released toward the turning mechanism by a predetermined amount.

3. The workpiece cutting device according to claim 1, wherein the separating mechanism is a separating piece insertion mechanism that inserts a thin plate-shaped separating piece into the vulnerable portion to separate the first-side workpiece and the second-side workpiece.

4. The workpiece cutting device according to claim 2, wherein the separating mechanism is a separating piece insertion mechanism that inserts a thin plate-shaped separating piece into the vulnerable portion to separate the first-side workpiece and the second-side workpiece.

5. The workpiece cutting device according to claim 1, wherein the separating mechanism is a drive mechanism that moves the second-side workpiece in a direction separating from the first-side workpiece to separate the second-side workpiece from the first-side workpiece at the vulnerable portion.

6. The workpiece cutting device according to claim 2, wherein the separating mechanism is a drive mechanism that moves the second-side workpiece in a direction separating from the first-side workpiece to separate the second-side workpiece from the first-side workpiece at the vulnerable portion.

7. The workpiece cutting device according to claim 1, comprising:
a transferring mechanism that transfers the second-side workpiece to a stacking jig for stacking the second-side workpiece separated from the workpiece and stacks the second-side workpiece.

8. The workpiece cutting device according to claim 2, comprising:
a transferring mechanism that transfers the second-side workpiece to a stacking jig for stacking the second-side workpiece separated from the workpiece and stacks the second-side workpiece.

9. The workpiece cutting device according to claim 3, comprising:
a transferring mechanism that transfers the second-side workpiece to a stacking jig for stacking the second-side workpiece separated from the workpiece and stacks the second-side workpiece.

10. The workpiece cutting device according to claim 4, comprising:
a transferring mechanism that transfers the second-side workpiece to a stacking jig for stacking the second-side workpiece separated from the workpiece and stacks the second-side workpiece.

11. The workpiece cutting device according to claim 5, comprising:
a transferring mechanism that transfers the second-side workpiece to a stacking jig for stacking the second-side workpiece separated from the workpiece and stacks the second-side workpiece.

12. The workpiece cutting device according to claim 6, comprising:
a transferring mechanism that transfers the second-side workpiece to a stacking jig for stacking the second-side workpiece separated from the workpiece and stacks the second-side workpiece.

13. A workpiece cutting method comprising, when a sheet-shaped or thin plate-shaped workpiece is cut into a first-side workpiece and a second-side workpiece by the workpiece cutting device according to claim 1:
a securing step of securing the first-side workpiece by the securing mechanism;
a gripping step of gripping the second-side workpiece by the gripping mechanism;
a folding step of turning the second-side workpiece gripped by the gripping mechanism about a boundary with the first-side workpiece as an axis by the turning mechanism; and
a separating step of separating the first-side workpiece and the second-side workpiece by the separating mechanism at a vulnerable portion formed at the boundary in the folding step.

14. A workpiece cutting method comprising, when a sheet-shaped or thin plate-shaped workpiece is cut into a first-side workpiece and a second-side workpiece by the workpiece cutting device according to claim 2:
a securing step of securing the first-side workpiece by the securing mechanism;
a gripping step of gripping the second-side workpiece by the gripping mechanism;
a folding step of turning the second-side workpiece gripped by the gripping mechanism about a boundary with the first-side workpiece as an axis by the turning mechanism; and
a separating step of separating the first-side workpiece and the second-side workpiece by the separating mechanism at a vulnerable portion formed at the boundary in the folding step.

15. A workpiece cutting method comprising, when a sheet-shaped or thin plate-shaped workpiece is cut into a first-side workpiece and a second-side workpiece by the workpiece cutting device according to claim 3:
a securing step of securing the first-side workpiece by the securing mechanism;
a gripping step of gripping the second-side workpiece by the gripping mechanism;
a folding step of turning the second-side workpiece gripped by the gripping mechanism about a boundary with the first-side workpiece as an axis by the turning mechanism; and
a separating step of separating the first-side workpiece and the second-side workpiece by the separating mechanism at a vulnerable portion formed at the boundary in the folding step.

16. A workpiece cutting method comprising, when a sheet-shaped or thin plate-shaped workpiece is cut into a first-side workpiece and a second-side workpiece by the workpiece cutting device according to claim 4:
a securing step of securing the first-side workpiece by the securing mechanism;
a gripping step of gripping the second-side workpiece by the gripping mechanism;
a folding step of turning the second-side workpiece gripped by the gripping mechanism about a boundary with the first-side workpiece as an axis by the turning mechanism; and
a separating step of separating the first-side workpiece and the second-side workpiece by the separating mechanism at a vulnerable portion formed at the boundary in the folding step.

17. A workpiece cutting method comprising, when a sheet-shaped or thin plate-shaped workpiece is cut into a first-side workpiece and a second-side workpiece by the workpiece cutting device according to claim 5:
a securing step of securing the first-side workpiece by the securing mechanism;
a gripping step of gripping the second-side workpiece by the gripping mechanism;
a folding step of turning the second-side workpiece gripped by the gripping mechanism about a boundary with the first-side workpiece as an axis by the turning mechanism; and
a separating step of separating the first-side workpiece and the second-side workpiece by the separating mechanism at a vulnerable portion formed at the boundary in the folding step.

18. A workpiece cutting method comprising, when a sheet-shaped or thin plate-shaped workpiece is cut into a first-side workpiece and a second-side workpiece by the workpiece cutting device according to claim 6:
a securing step of securing the first-side workpiece by the securing mechanism;
a gripping step of gripping the second-side workpiece by the gripping mechanism;
a folding step of turning the second-side workpiece gripped by the gripping mechanism about a boundary with the first-side workpiece as an axis by the turning mechanism; and
a separating step of separating the first-side workpiece and the second-side workpiece by the separating mechanism at a vulnerable portion formed at the boundary in the folding step.
